(19) United States
(12) Patent Application Publication
(10) Pub. No.: US 2025/0155142 A1
(43) Pub. Date: May 15, 2025

(54) STRUCTURE SYSTEM HAVING CHILLER AND MULTIPLE CENTRAL WATER-COOLED AIR QUALITY REGULATORS CONNECTED TO THE CHILLER

(71) Applicant: TSAN-CHIEH WANG, New Taipei City (TW)

(72) Inventor: TSAN-CHIEH WANG, New Taipei City (TW)

(21) Appl. No.: 18/412,881

(22) Filed: Jan. 15, 2024

(30) Foreign Application Priority Data
Nov. 10, 2023 (TW) 112143564

(51) Int. Cl. F24F 3/044; B01D 46/44; F24F 3/16; F24F 8/108; F24F 11/89; F24F 110/10; F24F 110/64; F24F 110/70

(52) U.S. Cl. CPC F24F 3/044; B01D 46/442; B01D 46/448; F24F 3/16; F24F 8/108; F24F 11/89; B01D 2279/50; F24F 2110/10; F24F 2110/64; F24F 2110/70; F24F 2221/16

(57) ABSTRACT

A structure system having a chiller and multiple central water-cooled air quality regulators connected to the chiller includes the chiller connected to the multiple central water-cooled air quality regulators. The central water-cooled air quality regulators include a central control unit, cooling tube banks, fan, motor, three-way valve, water pipes, air outlet, temperature-controlled electrically-driven air vane, return-air opening, high-efficiency filter, guide opening, indoor display controller, carbon dioxide CO₂ content sensor, temperature sensor, PM2.5 particle cleanliness sensor, and computer. The central control unit is connected to the computer to facilitate the control of the central water-cooled air quality regulators and connected to the chiller. The water pipes connected to the chiller are connected to a cooling tower on top of the building and to the central water-cooled air quality regulators at the stories of the building respectively to cool down the building and regulate air quality therein.

### 1. FIELD OF THE INVENTION

The invention relates to a structure system having a chiller and multiple central water-cooled air quality regulators connected to the chiller and more particularly to such a structure system having a chiller and multiple central water-cooled air quality regulators connected to the chiller, essentially comprising a chiller and multiple central water-cooled air quality regulators connected to the chiller. The central water-cooled air quality regulators comprise a central control unit, cooling tube banks, fan, motor, three-way valve, water pipes, air outlet, temperature-controlled electrically-driven air guide vane, return-air opening, high-efficiency filter, guide opening, indoor display controller, carbon dioxide CO₂ content sensor, temperature sensor, PM2.5 particle cleanliness sensor, and computer.

### 2. DESCRIPTION OF RELATED ART

Split air conditioners using a coolant as a cooling medium are suitable for apartment buildings and each essentially comprise an outdoor compressor and condenser unit and an indoor air outlet unit. Although split air conditioners do not have issues with secondary construction, their use is restricted to residences and shops. By contrast, a central water-cooled air conditioner 1 shown in FIG. 1 goes with a business building. The central water-cooled air conditioner 1 comprises a fan motor 12, heat exchanger coil 11, three-way valve 13, and temperature & air speed controller 14. The central water-cooled air conditioner 1 uses water as a cooling medium and thus has to be connected to an air box 15, air duct 16 and air outlet 17, which necessitates secondary construction. Furthermore, the installation of the central water-cooled air conditioner 1 requires each story of the building to have an air conditioning air duct installed to function as an air outlet, which not only necessitates secondary construction to the detriment of construction cost control and construction simplicity but also restricts its functionality to the regulation of air temperature.

### SUMMARY OF THE INVENTION

It is therefore one object of the invention to provide a structure system having a chiller and multiple central water-cooled air quality regulators connected to the chiller, essentially comprising a chiller and multiple central water-cooled air quality regulators connected to the chiller. The central water-cooled air quality regulators comprise a central control unit, cooling tube banks, fan, motor, three-way valve, water pipes, air outlet, temperature-controlled electrically-driven air guide vane, return-air opening, high-efficiency filter, guide opening, indoor display controller, carbon dioxide CO2 content sensor, temperature sensor, PM2.5 particle cleanliness sensor, and computer. The central control unit is connected to the computer to facilitate the control of the central water-cooled air quality regulator and connected to the chiller. The water pipes connected to the chiller are connected to a cooling tower on the top of the building. Furthermore, the water pipes are connected to the central water-cooled air quality regulators at all the stories of the building respectively to regulate the ambient temperature and the air quality therein. Designed for use in apartment buildings and business buildings, the invention not only has wide application but also dispenses with the need for the allocation of dedicated spaces for outdoor compressor and condenser units and the need for the secondary construction and tertiary construction required for the air ducts and electric power systems associated with indoor air outlet units.

The table below illustrates how the invention is distinguished from its conventional counterparts for use in buildings, residences and shops.

| | | | |
|---|---|---|---|
| model | split air | central water- | the invention |
| | conditioning | cooled air | (central water- |
| | system | conditioning | cooled air quality |
| | | system | regulator) |
| cooling | coolant | water | water |
| medium | | | |
| air | outdoor | central chiller | central chiller |
| conditioning | compressor | | |
| device | and condenser | | |
| | unit | | |
| regulation | air temperature | air temperature | carbon dioxide CO₂, |
| device | | | PM2.5 particle |
| | | | cleanliness, air |
| | | | temperature |
| indoor air | split indoor air | central air | central air |
| conditioning | conditioner | conditioning | conditioning |
| device | | indoor air | indoor air |
| | | conditioner | quality regulator |
| secondary | nil | air box, air | nil |
| construction | | duct, and air | |
| object | | outlet | |
| construction | secondary | secondary | secondary |
| characteristics | construction | construction | construction |
| | not required | required | not required |
| applicability | residences and | apartment | apartment buildings, |
| | shops | buildings, | business buildings, |
| | | business | residences and |
| | | buildings | shops |
| other | replacement of | nil | replacement of |
| characteristics | electrically-driven | | electrically-driven |
| | air outlet guide | | air outlet guide |
| | vane and | | vane and |
| | electrically-driven | | electrically-driven |
| | elevation filter | | elevation filter |

In conclusion, the invention integrates a conventional split air conditioning system and a conventional central water-cooled air conditioning system in terms of their advantages, exhibits none of their drawbacks, and is effective in regulating indoor air quality—a feature not found among existing, conventional air conditioners. Designed for use in apartment buildings and business buildings, the invention not only has wide application but also dispenses with the need for the allocation of dedicated spaces for outdoor compressor and condenser units and the need for the secondary construction and tertiary construction required for the air ducts and electric power systems associated with indoor air outlet units.

### BRIEF DESCRIPTION OF THE DRAWINGS

FIG. 1 (PRIOR ART) is a schematic view of a conventional central water-cooled air conditioning mini air conditioner system.

FIG. 2 is a first schematic view of a structure system having a chiller and central water-cooled air quality regulators connected to the chiller according to the invention.

FIG. 3 is a second schematic view of the structure system having a chiller and central water-cooled air quality regulators connected to the chiller according to the invention.

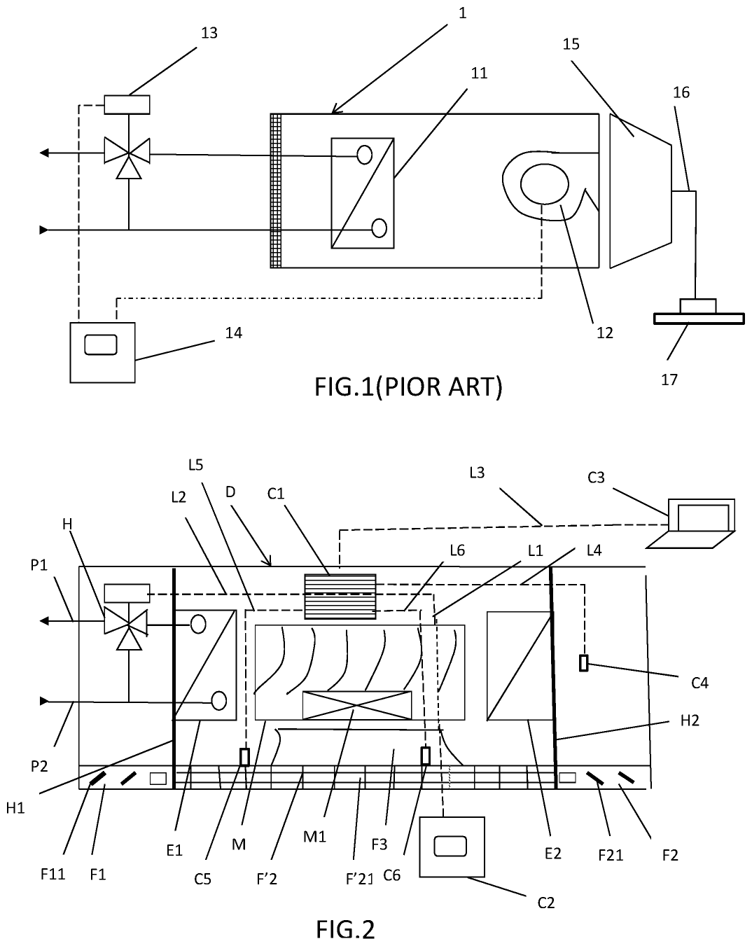

### DETAILED DESCRIPTION OF THE INVENTION

The technical features, structures and advantages of the invention will become apparent from the following detailed description taken with the accompanying drawings and embodiments.

Referring to FIGS. 2˜3, a structure system 1′ having a chiller and multiple central water-cooled air quality regulators connected to the chiller in accordance with the invention essentially comprises a chiller A connected to a cooling tower B and central water-cooled air quality regulators D. The central water-cooled air quality regulators D comprise a central control unit C1, cooling tube bank E, fan M1, motor M, three-way valve H, water pipes P1, P2, air outlet F1, temperature-controlled electrically-driven air guide vane F11, return-air opening F2, the high-efficiency filter F′21, guide opening F3, indoor display controller C2, carbon dioxide CO₂ sensor C4, PM2.5 particle cleanliness sensor C5, temperature sensor C6 and computer C3. The central control unit C1 is connected to the computer C3 by a connection line L3 to facilitate the control of the central water-cooled air quality regulators D. The water pipe P is connected to the chiller A and connected to the cooling tower B on the top of the building.

Referring to FIG. 2, regarding the central water-cooled air quality regulators D, the central control unit C1 is connected to the indoor display controller C2 by a connection line L1, to the three-way valve H by a connection line L2, to the computer C3 by a connection line L3, to the carbon dioxide CO₂ sensor C4 by a connection line L4, to the PM2.5 particle cleanliness sensor C5 by a connection line L5, and to the temperature sensor C6 by a connection line L6. A cooling tube bank E1 is disposed on the right side of a partition board H1. A cooling tube bank E2 is disposed on the left side of a partition board H2. The fan M1 and the motor M are disposed between the cooling tube bank E1 and the cooling tube bank E2. The air outlet F1 and the temperature-controlled electrically-driven air guide vane F11 are disposed to the lower left of the cooling tube bank E1 and the cooling tube bank E2. The air outlet F2 and the temperature-controlled electrically-driven air guide vane F21 are disposed to the right of the cooling tube bank E1 and the cooling tube bank E2. The return-air opening F′2 and the high-efficiency filter F′21 are centrally disposed leeward. The guide opening F3 is disposed below the fan M1.

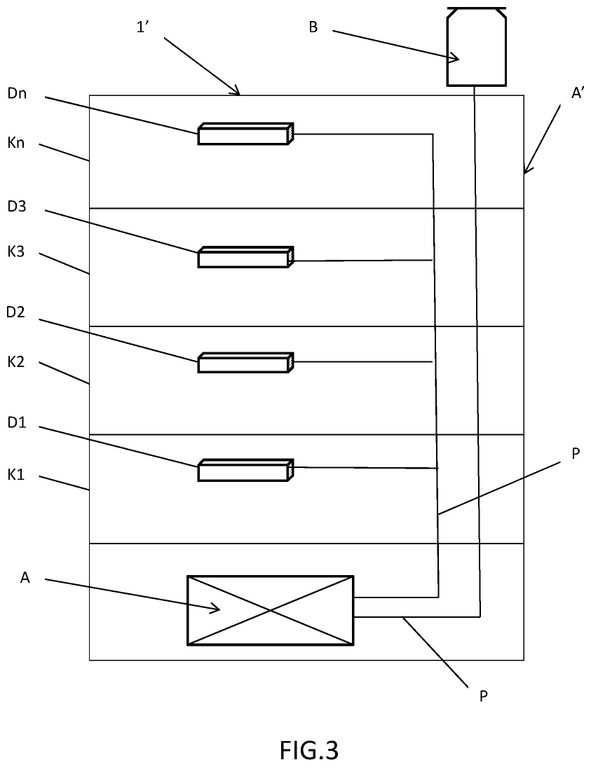

Referring to FIG. 3, the water pipe P connected to the chiller A is connected to the cooling tower B on the top of the business building A′, and the water pipe P is connected to the central water-cooled air quality regulators D1, D2, D3 . . . Dn mounted on stories K1, K2, K3 . . . Kn of the business building A′, cooling down the stories K1, K2, K3 . . . Kn of the business building A′.

What is claimed is:

1. A structure system having a chiller and multiple central water-cooled air quality regulators connected to the chiller, comprising the chiller connected to a cooling tower and the central water-cooled air quality regulators where;
the central water-cooled air quality regulators comprising a central control unit, cooling tube banks, fan, motor, three-way valve, water pipes, air outlet, temperature-controlled electrically-driven air guide vane, return-air opening, high-efficiency filter, guide opening, indoor display controller, carbon dioxide CO₂ sensor, PM2.5 particle cleanliness sensor, temperature sensor, and computer;
the central control unit is connected to an indoor display controller by a connection line, to a three-way valve by a connection line, to a computer by a connection line, to a carbon dioxide CO₂ sensor by a connection line, to a PM2.5 particle cleanliness sensor by a connection line, and to a temperature sensor by a connection line; and
one said cooling tube bank is disposed on a right side of a partition board, the other cooling tube bank is disposed on a left side of another partition board, the fan and the motor are disposed between the cooling tube banks, the air outlet and the temperature-controlled electrically-driven air vane are disposed to the lower left of the cooling tube banks, the air outlet and the temperature-controlled electrically-driven air vane are disposed to the right of the cooling tube banks, the return-air opening and the high-efficiency filter are centrally disposed leeward, the guide opening is disposed below the fan;
the water pipe connected to the chiller is connected to the cooling tower on top of a business building, and the water pipe is connected to the central water-cooled air quality regulators mounted on stories of the business building, so as to not only cool down the stories of the business building but also regulate indoor air quality therein.

2. The structure system having a chiller and multiple central water-cooled air quality regulators connected to the chiller according to claim 1, wherein the central control unit is connected to the computer and the indoor display controller by a connection line to facilitate control and management of the central water-cooled air quality regulators, connected to the chiller by the water pipes, and connected to the cooling tower on top of the business building by the water pipes.
